(19) United States
(12) Patent Application Publication
(10) Pub. No.: US 2012/0010769 A1
(43) Pub. Date: Jan. 12, 2012

(54) Method For Optimizing The Power Consumption Of A Hybrid And Plug-In Vehicle, And Hybrid And Plug-In Vehicle Implementing Said Method

(75) Inventors: Thomas Sourioux, Paris (FR); Nicolas Robart, Issy Les Moulineaux (FR)

(73) Assignee: PEUGEOT CITROEN AUTOMOBILES SA, Velizy Villacoublay (FR)

(21) Appl. No.: 13/256,177

(22) PCT Filed: Apr. 16, 2010
(86) PCT No.: PCT/FR2010/050734

§ 371 Date: Sep. 12, 2011

(30) Foreign Application Priority Data
Apr. 28, 2009 (FR) 0952777

(51) Int. Cl. B60W 20/00

(52) U.S. Cl. 701/22; 180/65.29; 903/907

(57) ABSTRACT

The invention relates to a method for optimising the power consumption of a hybrid and plug-in vehicle (1) comprising two traction modes, an electric (3) traction mode and a combustion (4) traction mode. Said method includes: determining the distance travelled between two consecutive recharges of the vehicle (1) by the mains; determining the electric energy available at a time “t” in an electric energy storage device (2); and determining a parameter “mu” according to the distance travelled between two consecutive recharges of the vehicle (1) by the mains and the electric energy available in the storage device (2).

### CROSS-REFERENCE TO RELATED APPLICATIONS

The present application is the US National Stage under 35 U.S.C. §371 of PCT/FR2010/050734 which was filed on Apr. 16, 2010 and which claims the priority of French application 0952777 filed on Apr. 28, 2009.

### BACKGROUND

The present invention relates to a method for optimizing the energy consumption of a plug-in hybrid vehicle. The invention also relates to a plug-in hybrid vehicle implementing this method. The specific goal of the invention is to propose a strategy for using the electrical energy of a plug-in hybrid vehicle in order to optimize the energy consumption during the use of the vehicle.

The invention applies to any type of plug-in hybrid automotive vehicle using several distinct energy sources for traction.

As used herein, “plug-in hybrid” vehicle refers to a hybrid vehicle with a storage device for electrical energy which is rechargeable through a power grid. To simplify the description, the term “hybrid” will be used instead of “plug-in hybrid” in the following text.

In the framework of the invention, a hybrid vehicle comprises two distinct energy storage devices. In particular, the vehicle comprises a first reversible energy storage device and a second non-reversible energy storage device. The first reversible energy storage device is an electrochemical storage source which stores electrical energy. This electrochemical storage source supplies electrical energy to a reversible electric motor, which transforms the electrical energy to mechanical energy. The storage source can be a Lithium-ion (Li-ion) battery, Nickel-metal hydride (NiMH) battery, Nickel-Zinc (Ni—Zn) battery, etc. The storage source can also take the form of a super capacitor. To simplify the description, the term “storage device” will be used in the following text. The second energy storage device is a fuel tank. The fuel tank supplies the internal combustion engine with fuel. The internal combustion engine transforms thermal energy, generated by the combustion of fuel, into mechanical energy. The first and second energy storage devices therefore constitute sources of energy which are transformed into mechanical energy to provide traction to the vehicle. One of the storage devices has a reversible power link, making it possible either to use the electrical energy contained in the storage device to accelerate the vehicle, or to use the kinetic energy of the vehicle during a deceleration to replenish the storage device.

However, the energy consumption of current hybrid vehicles varies as a function of the type of driving performed by the vehicle. In other words, a vehicle driven in the city runs at lower speed than the same vehicle driven in the countryside or on the expressway. The electrical motor of the vehicle is used in general to start and accelerate the vehicle before transitioning to the internal combustion engine, or to provide additional torque, in addition to the torque generated by the internal combustion engine, during high accelerations.

In addition, the cost of fuel increases year after year, in particular due to the depletion of the worldwide reserves of hydrocarbon resources. An important consequence of the increasing fuel cost is the fact that fuel efficiency is taken into account when purchasing a new vehicle. Indeed, vehicles with the lowest rate of fuel consumption expressed in Liter/100 km (or gallons/mile) and the lowest annual consumption estimate are the vehicles which will allow the buyer of a new vehicle to save the most fuel, year after year.

### BRIEF SUMMARY

The method disclosed herein solves this problem by optimizing the energy consumption of a hybrid vehicle during use, which favors the use of the electric motor over the use of the combustion engine to provide traction to the vehicle.

According to the method, all of the electrical energy available in the storage device will be consumed at the end of the distance traveled by the vehicle between the point of departure and the point of arrival. For this purpose, according to one of the important characteristics of the method, if the vehicle is equipped with an activated on-board navigation system, which establishes the global position of the vehicle, the remaining travel distance that the vehicle has to drive before the next recharge of the storage device on a 110-220V grid is calculated. This calculation is possible based on an evaluation of the distance to be traveled, the type of driving during the trip, the status of the electrical storage device and the fuel level in the tank.

Furthermore, according to the method, if the vehicle is equipped with an on-board navigation system that is not activated, the remaining travel distance that the vehicle has to drive before the next recharge of the storage device on the 110-220V grid is calculated. This distance is calculated, on the one hand, by determining the type of driving performed by the vehicle during the trip (difficult traffic, flowing traffic, street driving, expressway driving), and through analysis of the average speed and the number of stops of the vehicle, and, on the other hand, as a function of data obtained from a statistical study, which is memorized in advance, during the design phase, in the computer system of the vehicle. For instance, this statistical data can include the average vehicle speed and the average stop time, expressed as a percentage, during a normally traveled typical distance.

According to the method, all of the electrical energy available in the storage device will be consumed at the end of the distance traveled by the vehicle between two successive recharges on the grid, in order to consume as little fuel as possible for the traction of the vehicle.

The goal is thus the optimization of the energy consumption of a plug-in hybrid vehicle with two traction modes, respectively electrical and thermal traction, in which,
determining a distance traveled between two successive recharges on the grid,
an evaluation is made of the electrical energy available in the electrical energy storage device at instant “t”, and
a parameter “mu” is defined as a function of the distance traveled between two successive recharges of the vehicle on the grid and the electrical energy available in the storage device.

The method comprises any of the following characteristics:
if the navigation system is activated, in order to determine the distance traveled between two successive recharges of the vehicle on the grid, a calculation is made of the distance traveled by the vehicle as a function of the point of departure and the point of arrival, and as a function of the type of driving done by the vehicle over this distance;
if the navigation system is not activated, in order to determine the distance traveled by the vehicle between two successive recharges on the grid, an evaluation is made starting from statistical data of the type of driving as a function of the average speed of the vehicle, and of the percentage of average stop time over a normally traveled typical distance;
if the parameter “mu” is lower than a specific value, the electric motor is used to provide traction to the vehicle;
if the parameter “mu” is higher than a specific value, the combustion engine and electric motor are used in combination to provide traction to the vehicle;
an indicator is displayed on a screen representing the electrical energy consumption of the vehicle;
if the charge status of the storage device reaches zero prior to the end of the distance traveled by the vehicle, the combustion engine is used to provide traction to the vehicle during the remaining distance, and an indicator is displayed on a screen indicating the distance traveled with electrical energy;
an indicator is displayed on a screen indicating the remaining travel distance before recharging the storage device.

The invention has also as a goal a plug-in hybrid vehicle implementing the previously defined method.

### BRIEF DESCRIPTION OF THE SEVERAL VIEWS OF THE DRAWINGS

The method will be better understood by reading the following description and by examining the accompanying figures. The figures are provided for illustration purposes only and are not in any way limiting the invention. The figures show:

FIG. 1 is a a schematic representation of a vehicle in which a method for optimizing energy consumption is implemented;

FIG. 2 is a curve representing the status change of the electrical energy storage device, as a function of the distance traveled by the vehicle;

FIG. 3 is a curve representing the stop distance of the vehicle according to the invention before recharging the electrical energy storage device, as a function of the average speed of said vehicle;

FIG. 4 is a curve representing the cost of the energy consumption of the vehicle in which the method is implemented, as a function of the stop distance of the vehicle before recharging the electrical energy storage device; and

FIG. 5 is a flow chart of the method.

### DETAILED DESCRIPTION

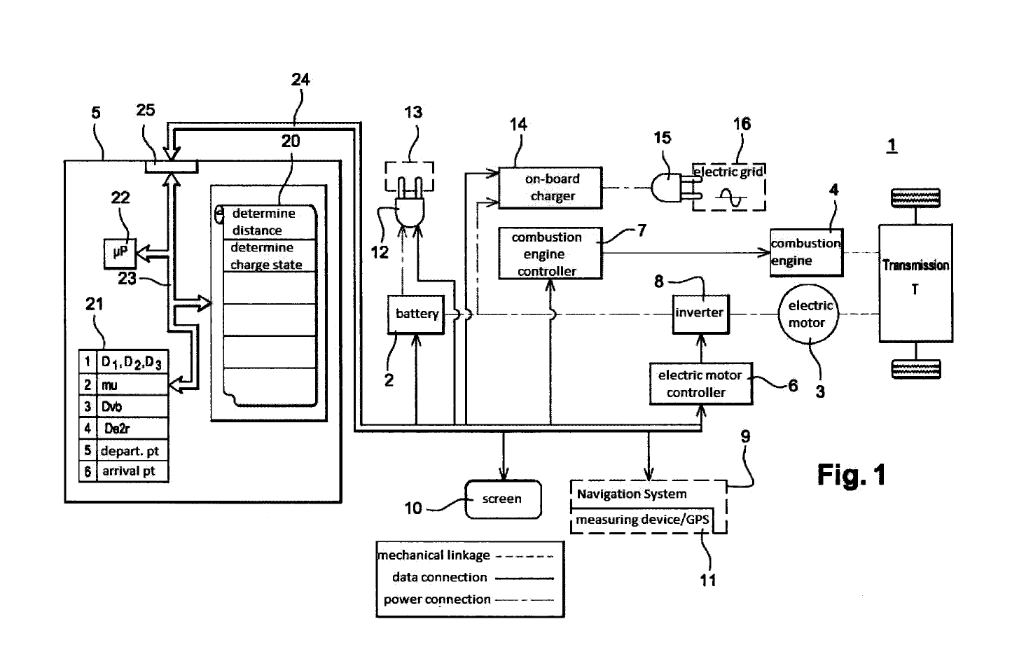

FIG. 1 is a schematic representation of a hybrid powertrain used in numerous design vehicles of current design. Most require no modification or only minor modifications. Indeed, some of the programs employed by the control devices of the vehicle require only adaptations in order to take into account the specific features of the method, which will be described below.

Vehicle 1 is equipped with an electrical energy storage device 2. This storage device 2 supplies electrical energy to an electric motor 3, in order to compensate or replace a combustion engine 4, and to provide traction to the vehicle 1 via transmission T.

FIG. 1 shows electrical connections for transferring information or power between the different control devices of the vehicle. The electric motor 3 and combustion engine 4 are connected by mechanical linkages. These mechanical linkages, the power and data transfer connections, and the operation of the electrical motor 3 and combustion engine 4 do not differ from current technology. Therefore, they do not require further description. Only the specific features characterizing the method and device will be described.

To control all of the components of the vehicle 1 and in particular the electric motor 3 and combustion engine 4, the vehicle comprises a computer system 5. This computer system 5 can be a processor. It can consist also of several processors. The computer system 5 commands on the one hand, a control unit 6 of the electric motor 3, and on the other hand, a control unit 7 of the combustion engine 4. The control unit 6 commands the electric motor 3 via an inverter 8 supplied by storage device 2.

Vehicle 1 furthermore comprises a navigation system 9 associated with a display device such as screen 10. The navigation system 9 is equipped with a global positioning device 11 such as a GPS.

The computer system 5 controls and monitors the status of the storage device 2. Since the vehicle is a hybrid, it has a means for recharging the storage device 2. A first means of recharging the storage device 2 includes of a plug 12 with suitable to allow the storage device 2 to be plugged directly into a quick charge terminal 13, which is available in some parking places. A second possible means of recharging the storage device 2 includes a charger 14 on board of the vehicle provided with a plug 15 which allows for the storage device 2 to be plugged into the domestic or sector grid 16 of 110-220V.

In both cases, the command to start charging the storage device 2 is generated by the computer system 5 and transmitted to the plug 13 or on-board charger 14.

Vehicle 1 also contains an energy storage device (not shown) to supply fuel to the combustion engine 4.

The actual operation of the vehicle 1 however results in high energy consumption, which is characterized by increased energy costs.

To resolve this problem, the method optimizes the energy consumption of the vehicle 1 by consuming all of the electrical energy available in the storage device 2, so that at the end of the travel of vehicle 1, the storage device 2 is completely empty.

For this purpose, the vehicle 1 comprises two operational phases. A first phase during which the storage device 2 is emptied in order to consume the electrical energy and a second phase corresponding with “full hybrid operation” during which the energy balance of the storage device 2 is zero.

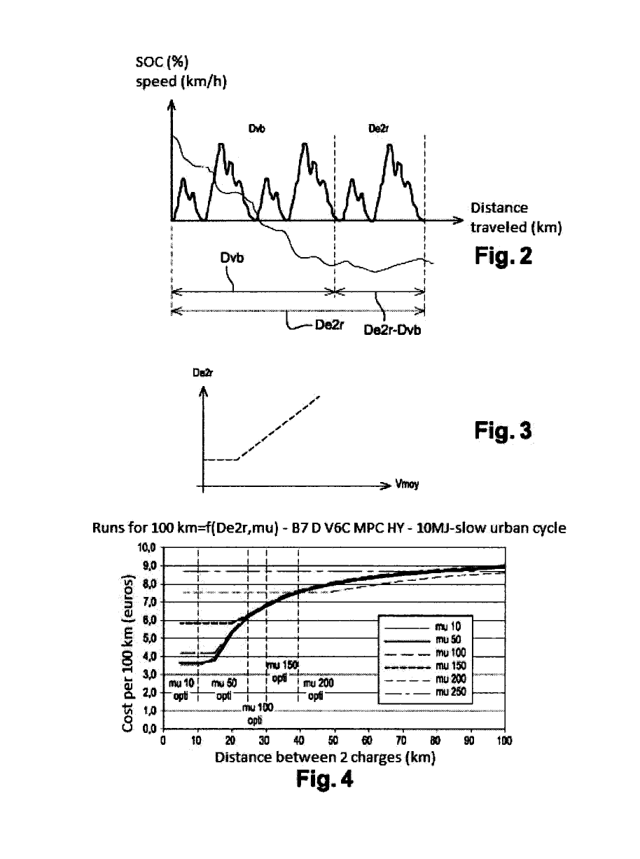

FIG. 2 illustrates these two operational phases of the vehicle 1. The figure shows a curve illustrating the change in charge status of the storage device 2, as a function of the distance traveled by vehicle 1. It is assumed here that the initial charge state is at a maximum following a recharge of the storage device 2. It is noted that for a certain distance traveled by the vehicle 1, the charge status of the storage device 2 is reduced more or less rapidly as a function of the speed variations of the vehicle 1. It is also noted that the first operational phase corresponds with the distance traveled by the vehicle 1 until the storage device 2 is empty, referenced Dvb. The distance traveled between the first and second phase of operation corresponds with the distance traveled between two recharges of the storage device 2, referenced De2r. From this, we can deduce the distance traveled during the second phase corresponding to De2r-Dvb. To be noted that in order to optimize the energy consumption of the vehicle Dvb=De2r. In other words, the electrical energy of the storage device 2 must be used during the whole travel of the vehicle 1.

To achieve the objective of optimizing the energy consumption of the vehicle 1, the method comprises two steps.

In a first step, when the on-board navigation system is activated, an evaluation is made of the type of driving of the vehicle 1, in other words, whether the vehicle 1 is driving in the city, on a road or an expressway. To determine the type of driving, the navigation system 9 uses the global positioning device 11 to establish the geographical position of the vehicle 1, the points of departure and arrival, the theoretical remaining driving distance for the vehicle 1 and the estimated remaining driving time, depending on whether or not there are any possible traffic delays. Starting from this data acquired through the global positioning device 11, the navigation system 9 determines whether the vehicle 1 is being driven on a road, in the city or on an expressway. The navigation system 9 calculates in this way the distance that vehicle 1 must travel before a recharge of the storage device 2 will take place. To obtain optimal energy consumption Dvb=De2r, it is therefore necessary to adapt the energy consumption strategy of the vehicle, in order for the storage device to arrive empty at the point of destination.

In a second step, when the on-board navigation system is not activated and the global positioning device 11 is not available, the type of driving of the vehicle 1 is evaluated (city slow, city flowing, road, expressway) by means of data obtained from statistical studies, illustrated by the curve of FIG. 4. This statistical study is conducted starting from the average speed and the percentage of average stop time during a typical distance normally driven by vehicle 1. Consequently, it is possible to determine the remaining driving distance before recharging the storage device 2 on the grid, as a function of the road behavior of the driver relative to the average speed of vehicle 1. Starting from these statistics we know, for instance, that 50% of all driving on national roads is over distances greater than 50 km. From this fact, the remaining driving distance before recharging storage device 2 on the grid is 50 km.

Once the remaining driving distance De2r of vehicle 1 before recharging the storage device 2 is determined, with or without navigation system 9, it is possible to calculate, as a function of the curve shown in FIG. 4, the gain in energy consumption of the vehicle 1. The gain in energy consumption can be translated inversely in the estimated cost of energy consumption, for a distance of 100 km traveled by the vehicle. This consumption gain is obtained as a function of the remaining distance to be traveled before recharging the storage device 2, the electrical energy available in storage device 2, and a parameter “mu”, which will be defined below. The energy consumption gain curve is defined for each type of driving. Starting from this curve, the optimal mu parameter is deduced as a function of the predetermined distance between two recharges of the storage device 2 and the desired maximum consumption gain. Parameter mu is a representation of the energy optimization strategy of vehicle 1. In other words, when mu is low, energy is quickly expended and when mu is high, there is time to recharge the electrical energy storage device. On this curve there is mandatorily one parameter value mu for which a zero balance of the storage device 2 is obtained, in other words for which the usage matches exactly what is available in storage device 2.

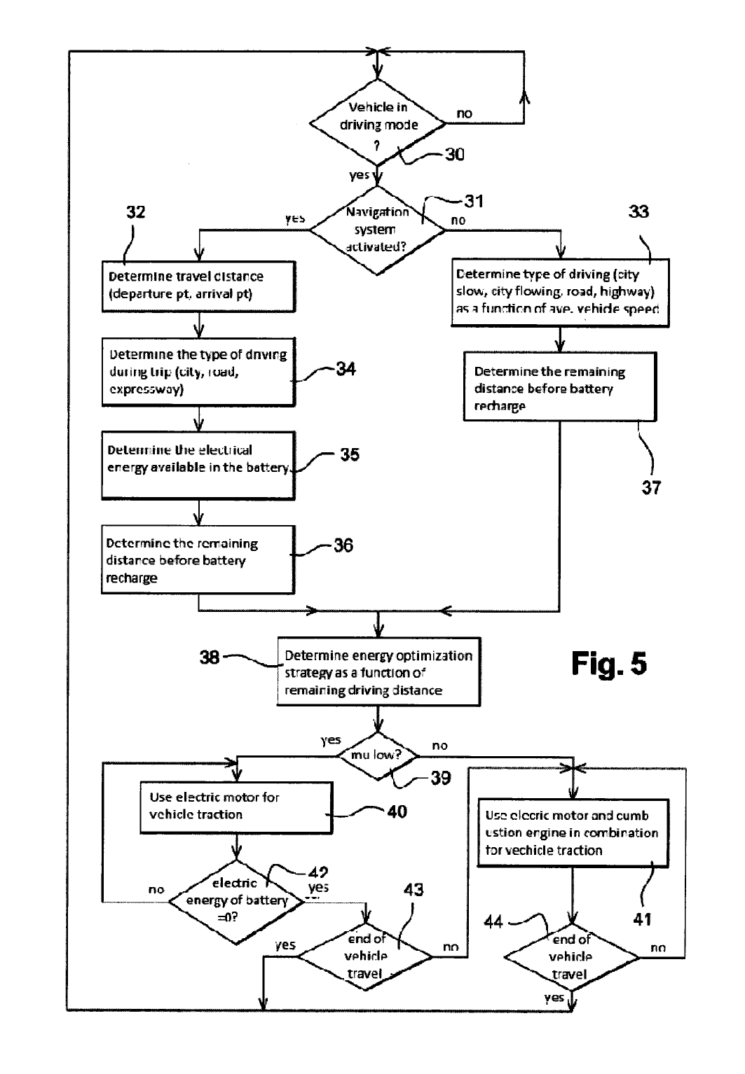

Parameter mu will vary as a function of the stop distance between two recharges De2r, the available electrical energy in storage device 2 and the type of driving. In the example of FIG. 5, as long as the travel distance De2r is less than 10 Km, a parameter mu must be selected equal to 10 (mu10). For a distance between 10 and 25 Km, a parameter mu must be selected equal to 50 (mu50).

To implement the invention, the computer system 5 comprises a program memory 20 and a data memory 21 connected to a microprocessor 22 via a communication bus 23. The computer system 5 is connected with the different control elements of vehicle 1 described above, through the intermediary of another communication bus 24. The computer system 5 comprises an input/output interface 25, which connects bus 23 and 24.

The activities managed by computer system 5 are commanded by the microprocessor 22. In response to the instruction codes recorded in program memory 20, the microprocessor 22 produces commands intended for the different control devices of vehicle 1.

The program memory 20 comprises for this purpose several program zones, corresponding respectively to a sequence of operations. A first operation corresponds with the calculation of the distance that can be traveled by the vehicle 1 as a function of the electrical traction and the pace or speed of the vehicle 1. A second operation corresponds with evaluating the charge state of the storage device 2 of the vehicle 1.

FIG. 5 is an example of the flow chart of the method. A general program comprising all sub-programs 30 to 44, organizes the succession of as many steps as there are sub-programs, in the following manner.

The flow chart shows the preliminary step 30 in which the operational mode of vehicle 1 is determined. In other words, whether the vehicle is in a stop or in drive mode. If vehicle 1 is in a drive mode, step 31 is executed, otherwise step 30 is reiterated.

Step 31 evaluates whether the on-board navigation system 9 of the vehicle is activated. If the navigation system 9 of the vehicle 1 is activated, step 32 is executed, otherwise, step 33 is executed.

Step 32 calculates the theoretical distance to be driven by the vehicle 1 as a function of the data acquired by means of the global positioning device 11. This data can include the points of departure and arrival of the path traveled by the vehicle 1, and the road traffic that the vehicle 1 is likely to encounter. Once the theoretical distance is calculated, step 34 is executed.

Step 34 evaluates the type of driving that the vehicle 1 will have to perform during the trip, in other words, whether the vehicle will drive through the city, on roads or expressways. Once the type of driving is established, step 35 is executed.

Step 35 evaluates the available electrical energy in the storage device 2. Once the charge status of the storage device 2 is established, step 36 is executed.

Step 36 calculates the remaining distance before recharging the storage device 2. Once this distance is calculated, step 38 is executed.

If the navigation system 9 is not activated during step 33 then the type of driving of the vehicle is evaluated as a function of the average vehicle speed. Once the type of driving is determined, step 37 is executed.

Step 37 calculates the remaining travel distance before recharging the storage device 2 as a function of the average vehicle speed. Once this distance is calculated, step 38 is executed.

Step 38 calculates the coefficient “mu”, which corresponds to the energy optimization strategy of the vehicle as a function of the distance calculated in step 36 or 37. Once the coefficient mu is calculated, step 39 is executed.

Step 39 evaluates whether the coefficient mu is low, in other words, whether mu is lower than a predetermined value. If the coefficient mu is low, step 40 is executed, if not. step 41 is executed.

During step 40, the electric motor 3 is used to provide traction to the vehicle. When step 40 is completed, step 42 is executed.

During step 41, the combustion engine 4 and electric motor 3 are used in combination to provide traction to the vehicle 1. When step 41 is completed, step 44 is executed.

Step 42 evaluates whether the storage device 2 is empty. If the storage device is empty, step 43 is executed, if not, step 40 is reiterated.

Step 43 evaluates whether the vehicle 1 has completed the trip. If the vehicle has not completed the trip, step 44 is executed, if not, step 30 is reiterated.

Step 44 evaluates whether the vehicle has completed the trip. If the vehicle has completed the trip, step 30 is reiterated, if not, step 41 is reiterated.

1. A method for optimizing the energy consumption of a plug-in hybrid vehicle comprising an electrical motor to provide an electrical traction mode and an internal combustion engine to provide a thermal traction mode, the method comprising
calculating a distance between two successive recharges of the vehicle on an electrical power grid,
evaluating the amount of electrical energy available at time “t” in an electrical energy storage device, and
calculating a parameter “mu” as a function of the distance traveled between two successive recharges of vehicle on the electrical power grid and the electrical energy available in the electrical storage device.

2. The method according to claim 1, wherein the vehicle includes a navigation system, the method including a step of determining if the navigation system is activated, and, if the navigation system is activated, the step of calculating the distance traveled between two successive recharges of vehicle on the grid comprises:
calculating the travel distance of the vehicle as a function of the point of departure and the point of arrival, and
determining the type of driving of the vehicle over the distance to be traveled.

3. The method according to claim 1, wherein the vehicle does not include an activated navigation system the step of calculating the distance traveled by the vehicle between two successive recharges of the vehicle on the grid comprising:
starting from statistical data, determining the type of driving as a function of the average vehicle speed, and
determining the percentage of average stop time over a normally driven typical distance.

4. The method according to claim 1 wherein, when parameter “mu” is lower than a predetermined threshold, the electric motor is used to provide traction to the vehicle.

5. The method according claim 1 wherein, when parameter “mu” is higher than a predetermined threshold, the combustion engine is used to provide traction to the vehicle.

6. The method according to claim 1 wherein an indicator is displayed on a screen, the indicator being representative of the optimized consumption of electrical energy of the vehicle.

7. The method according to claim 1 wherein if the charge status of the electrical storage device reaches zero before the end of the trip of the vehicle (1), then
the internal combustion engine is used to provide traction to the vehicle for the rest of the distance, and
an indicator is displayed on a screen indicating the distance traveled with electrical energy.

8. The method according to claim 1 wherein an indicator is displayed on a screen indicating the travel distance before recharging the electrical storage device.

9. A plug-in hybrid vehicle adapted to implement the method claim 1.
